(19) United States
(12) Patent Application Publication
(10) Pub. No.: US 2007/0234484 A1
(43) Pub. Date: Oct. 11, 2007

(54) Tool for applying an insect screen to a frame

(76) Inventor: James V. Guffey, Ft. Myers, FL (US)

Correspondence Address: James V. Guffey, 6368 Emerald Pine Circle, Ft. Myers, FL, 33912, US

(21) Appl. No.: 11/397,396

(22) Filed: Apr. 5, 2006

(51) Int. Cl. B26B 11/00

(52) U.S. Cl. 7/158

(57) ABSTRACT

A hand held tool is used to install screening material in frame members of pool or lanai enclosures. The frame members have receiving tapes in recesses therein or adhesively fastened to a surface thereof. The receiving tape has upstanding stems thereon with mushroom heads at an outer end. The hand held tool is a handle that has at one end thereof a rotatable wheel thereon. The rotatable wheel has a multiple of lateral ridges thereon and the outer circumferences of the ridges have blunted points thereon. When installing a screening frame member, the wheel will engage an outer surface of the screening material and push the interstices of the fabric into the receiving tape and the screening material will be held in place by being located below the mushroom heads of the receiving tape. Another end of the handle has a knife located therein for the purpose of cutting excess material after an installation.

### FIELD OF THE INVENTION

A tool is used to apply or fasten an insect screen to a frame which is used in lanai or pool enclosures. A copending application Ser. No. 11/337,845 discloses and claims a novel screen fastening system involving the use of fastening strips having tiny mushroom heads on top of stems embedded in a tape that will easily accept the screening material to be fastened thereto.

### BACKGROUND OF THE INVENTION

The tool described hereafter is a hand held tool that will push screening material having interstices between the warp and the weft that will push the screening material over the tiny mushroom heads into an engagement therewith.

### BRIEF DESCRIPTION OF THE INVENTION

The inventive tool is essential in applying a screen material to a frame member of a screen enclosure. The frame members can be vertical support members or horizontal connection members that make up en enclosure over a pool or a backyard lanai. Prior applications or installations have used splines that are embedded in grooves in any of the support members. The splines were applied by way of a tool having a wheel at one end thereof which would roll the spline and the screening material simultaneously into the groove, described above, to be fastened therein. A person installing the screen material and the spline had to be somewhat skilled to accomplish the above noted task. While installing the screen material, it often resulted in the undesirable effect of cutting the screen material or fabric because the edges of the single wheel would subject the screen to a cutting action between the tool wheel edge and the edge of the groove.

The present tool consists of a wide wheel contained in an end of a hand-held tool that will not contact any of the edges prevalent in a recess where the screen material is to be installed. The recesses in the support frame members have installed therein a somewhat narrow tape that has upstanding stems which are topped by mushroom shaped heads. When the tool is used to apply the screening material, the outer circumference of the tool pushes the interstices of the woven material into the stems and below the mushroom heads to be fastened therein and onto the tape that is already in the groove. There is no danger of cutting the screening material when applying pressure onto the hand-held tool.

Another end of the tool has an adjustable knife therein which is instrumental in cutting the excess screening material after the screening material has been applied to the recessed tape.

### BRIEF DESCRIPTION OF THE DRAWINGS

FIG. 1 is a side view of the hand held tool;

FIG. 2 is a top vie of the hand held tool;

FIG. 3 is an exploded view of the hand held tool;

FIG. 4 shows a view of how the screening material is installed on a tape;

FIG. 5 shows the screening material after it has been installed by the tool.

### DETAILED DESCRIPTION OF THE INVENTION

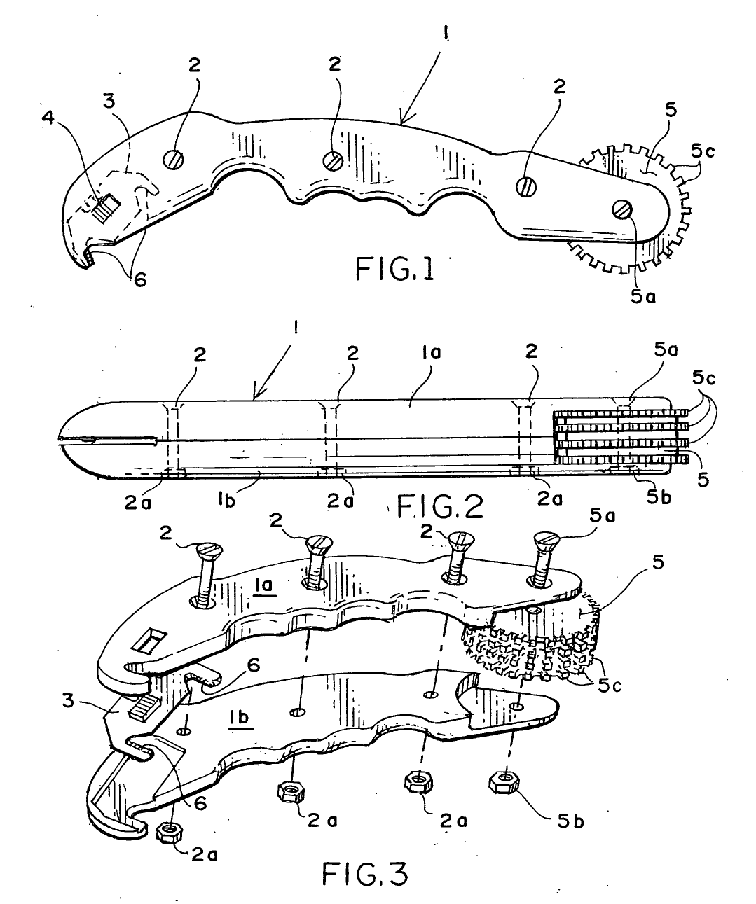

FIG. 1 illustrates the hand held tool in a side view. The tool handle 1 has at one end thereof a pressure wheel 5 which is separated at its circumference by several lateral and circular ridges 5b. The outer circumference of the ridges have points thereon. The points of the ridges are blunted at 5a so that the blunted points and the ridges can encounter either the warp or the weft threads of the woven screen material to press the material into or onto the receiving tape in the groove in the supporting frame members. The handle of the tool consists of two halves 1a and 1b (FIG. 2) which are held together by way of screws 2 having nuts 2a (FIG. 3) thereon to by fastening the two halves 1a and 1b together. The screws 2 pass through the holes 2a in both halves of the tool. The other end of the tool has a knife 3 installed therein which is similar to knifes used in box cutting instruments. The knife, once it is installed in the handle 1, can be adjusted to different cutting modes by way of the screw 4. The different cutting modes can be observed at 6 at the end of handle 1.

FIG. 2 illustrates the hand held tool from a top view. The same reference characters are applied as were explained in FIG. 2. The pressure wheel 5 is shown as having several parallel ridges 5b that are blunted at their outer circumference as was explained in FIG. 1. The wheel 5 is held in rotating way in the handle 1 by way of the axle 5a.

FIG. 3 is an exploded view of the hand held tool of FIGS. 1 and 2. Again, the same reference characters have been applied as before. The screws 2 are held in place by way of nuts 5b and so is the axle 5a held in place by way of the nut 5b.

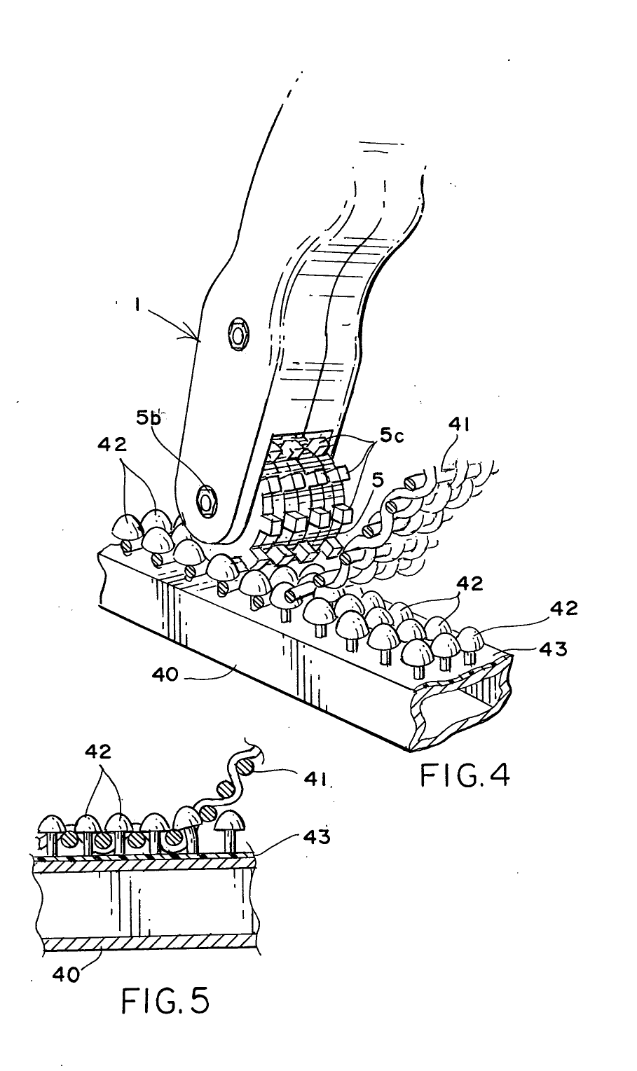

FIG. 4 shows the hand held tool in action while pressing the screen material 41 onto or into the tape 42 which is located in a recess of the frame member 40. As noted above, the tape 42 has a multiple of mushroom shaped heads 43 thereon which will capture the screening material below their heads once the material 41 is pushed below their heads.

FIG. 5 shows the screening material 41 installed in the tape 42 under the head 43 of the multiple of mushroom heads 43. the tape 42 is installed in a recess of the frame member 40 or the tape could be installed on an outer surface of any of the frame members 40 by way of an adhesive.

### Operation

According to all of the Figs., but especially FIG. 4, The tool is used to engage an outer surface of the material 41 by way of the tool described above. The outer surface of the tool wheel, which has the lateral ridges 5b thereon, will engage the warp and weft threads of the material 41 and push the same into the tape 42 and under the mushroom heads 43. The fact that the lateral ridges 5b have blunted points 5c thereon aids in engaging the warp and weft threads of the screening material 41. An advantage of using the tape having the mushroom heads thereon is in that the material 41 can be moved about the tape for adjustment and aligning purposes without sticking or adhering thereto as would be the case when hook and loop fasteners are being used.

What I claim is:

1. A tool for engaging a screen material with a frame member of an enclosure including a handle, said handle having at one end thereof a rotatable pressure wheel, said pressure wheel having a multiple of lateral ridges thereon, said ridges having blunted points thereon.

2. The tool of claim 1 including a knife located at another end of said handle.

3. The tool of claim 1, wherein said handle consists of two halves held together by fasteners.
